(19) United States
(12) Patent Application Publication
(10) Pub. No.: US 2024/0255299 A1
(43) Pub. Date: Aug. 1, 2024

(54) ELECTRICALLY POWERED VEHICLE AND NAVIGATION DEVICE THEREOF

(71) Applicant: TOYOTA JIDOSHA KABUSHIKI KAISHA, Aichi-ken (JP)

(72) Inventors: Takumi MIZUOCHI, Toyota-shi (JP); Masashi KAMIYA, Okazaki-shi (JP)

(21) Appl. No.: 18/420,766

(22) Filed: Jan. 24, 2024

(30) Foreign Application Priority Data
Jan. 26, 2023 (JP) 2023-010107

(51) Int. Cl. G01C 21/36; B60H 1/00; B60L 58/12; G01C 21/34

(52) U.S. Cl. CPC G01C 21/3617; B60H 1/00021; B60L 58/12; G01C 21/3469; B60H 2001/00185

(57) ABSTRACT

A navigation device mounted on an electrically powered vehicle which includes a battery that supplies electricity to an electric motor and an air conditioner. The navigation device includes a controller. The controller is configured to obtain an electricity amount for traveling and an electricity amount for air conditioning, these electricity amounts are needed during travel from a current location to a destination specified by a user. The controller is configured to add the electricity amount for air conditioning to the electricity amount for traveling to obtain a total amount of electricity. When a remaining amount of electricity stored in the battery is less than the total amount of electricity, the controller operates a display to show a site where the vehicle is reachable with the remaining amount of electricity and is located between the current location and the destination, along with positional information on a charging spot around the site.

### CROSS REFERENCE TO RELATED APPLICATION

This application claims priority to Japanese Patent Application No. 2023-010107 filed on Jan. 26, 2023, which is incorporated herein by reference in its entirety including the specification, claims, drawings, and abstract.

### TECHNICAL FIELD

The present disclosure relates to an electrically powered vehicle and a navigation device thereof, and in particular to the display of navigation screen in response to the operation of an air conditioner mounted in the vehicle.

### BACKGROUND

The electrically powered vehicles such as Battery Electric Vehicles (BEV) and Plug-in Hybrid Electric Vehicles (PHEV) are known. The electrically powered vehicle comprises an electric motor as the driving source and a battery that supplies power to the electric motor. When the remaining amount of electricity stored in the battery (SOC: State Of Charge) drops, the vehicle must be moved to a charging spot to charge the battery. The charging spot is a charging device or facility, also known as a charging station.

The battery of an electrically powered vehicle not only supplies power to the electric motor for driving, but also to the air conditioner mounted in the vehicle. Therefore, the distance a vehicle can travel varies depending on whether the air conditioner is used or not, or on the amount of electricity used by the air conditioner.

Patent Literature 1 (JP 2011-255686 A) discloses that in an Battery Electric Vehicle, an amount of electricity for traveling and an amount of electricity for air conditioning required to reach a destination set in a navigation device are calculated, a total amount of electricity is calculated by adding the amount of electricity for traveling to the amount of electricity for air conditioning, and if the remaining amount of electricity stored in the battery (SOC) is smaller than the total amount of electricity, the output of the air conditioner is limited to enable the vehicle to reach its destination.

### CITATION LIST

### Patent Literature

PATENT LITERATURE 1: JP 2011-255686 A

### SUMMARY

In the air conditioner described in Patent Literature 1 (JP 2011-255686 A), the air conditioning output is limited against the will of the vehicle occupant, which may result in loss of comfort in the cabin. On the other hand, if the air conditioner is enabled to operate according to the occupant's will, the vehicle may not be able to reach the destination set in the navigation device due to insufficient remaining amount of electricity stored in the battery.

Therefore, it is desired to enable the air conditioner to operate according to the occupant's setting when the remaining amount of electricity stored in the battery (SOC) is low, while allowing the occupant to know the site where the vehicle can reach between the current location and the destination set in the navigation device when the air conditioner is operated according to the occupant's setting.

An object of the present disclosure is to enable the occupant to know the site where the electrically powered vehicle can reach when the occupant causes the air conditioner to operate.

A navigation device mounted on an electrically powered vehicle which includes an electric motor as a driving source, an air conditioner, and a battery that supplies electricity to the electric motor and the air conditioner. The navigation device includes a controller that operates a display to display a guidance route from a current location to a destination specified by a user. The controller is configured to obtain an electricity amount for traveling and an electricity amount for air conditioning. The electricity amount for traveling denotes an amount of electricity needed by the vehicle to travel from the current location to the destination. The electricity amount for air conditioning denotes an amount of electricity needed by the air conditioner to keep functioning during travel from the current location to the destination. The controller is configured to add the electricity amount for air conditioning to the electricity amount for traveling to obtain a total amount of electricity. When a remaining amount of electricity stored in the battery is less than the total amount of electricity, the controller operates the display to show a site where the vehicle is reachable with the remaining amount of electricity and is located between the current location and the destination, along with positional information on a charging spot around the site.

According to this configuration, the occupant can know the site that the electrically powered vehicle can reach when the occupant causes the air conditioner to operate. In addition, since the charging spot in the vicinity of the reachable site are displayed on the display, the occupant can easily move the electrically powered vehicle to the charging spot and charge the battery.

In the navigation device according to the present disclosure, the air conditioner may be configured to be operable in a plurality of air conditioning modes comprising a mode to reduce an electric load.

In the navigation device according to the present disclosure, the vehicle may include an input unit configured to receive an input of an air conditioning mode selected from the plurality of air conditioning modes by a user. The controller may be configured to operate the display to show a site where the vehicle is reachable with the air conditioner actuated in the air conditioning mode received by the input unit, along with positional information on a charging spot around the site reachable in the received air conditioning mode.

According to this configuration, the occupant can select an air conditioning mode to determine a reachable site (cruising range) from the plurality of air conditioning modes, so the occupant can determine the air conditioning mode by considering the balance between cabin comfort and cruising range.

In the navigation device according to the present disclosure, the controller may be configured to operate the display to show a map on which a guidance line is indicated on a route from the current location to a site (the site) where the vehicle is reachable in a currently selected air conditioning mode (the selected air conditioning mode), with a charging spot mark indicated at a location of a charging spot (the charging spot) around the site reachable in the currently selected air conditioning mode (the selected air conditioning mode). The controller may be further configured to operate the display to show the guidance line and the charging spot mark with a same color or a same pattern.

According to this configuration, the occupant can clearly know the charging spot corresponding to the reachable site of the electrically powered vehicle.

In the navigation device according to the present disclosure, the controller may be configured to operate the display to show a map on which a charging spot mark is indicated at a location of a charging spot with a color or a pattern. The controller may be further configured to operate the display to show a charging spot mark indicating, with another color or another pattern, a charging spot (the charging spot) around a site (the site) where the vehicle is reachable in a currently selected air conditioning mode (the selected air conditioning mode).

This configuration also allow the occupant to clearly know the charging spot corresponding to the reachable site of the electrically powered vehicle.

An electrically powered vehicle of the present disclosure includes the navigation device described above.

According to the present disclosure, the occupant can know the site where the electrically powered vehicle can reach when the occupant causes the air conditioner to operate.

### BRIEF DESCRIPTION OF DRAWINGS

Embodiments of the present disclosure will be described based on the following figures, wherein:

FIG. 1 is a schematic block diagram of an electrical configuration of an electrically powered vehicle.

FIG. 2 is a table of relationship between air conditioning modes and electric loads.

FIG. 3 is a flowchart showing processes performed by a controller.

FIG. 4A is an example of the display screen when the air conditioning mode is “Standard”.

FIG. 4B is an example of the display screen when the air conditioning mode is “ECO”.

FIG. 5A is an example of the display screen when the air conditioning mode is “Minimum”.

FIG. 5B is an example of the display screen when the air conditioning mode is “OFF”.

FIG. 6A is an example of the display screen showing guidance lines and charging spot marks for the plurality of air conditioning modes.

FIG. 6B is an another example of the display screen.

### DESCRIPTION OF EMBODIMENTS

### Overview

The embodiments of the present disclosure are described below based on the drawings. The present disclosure is not limited to the embodiments described herein. The features of multiple embodiments and variations may be combined as appropriate. In all drawings, identical elements are marked with the same symbol and redundant explanations are omitted.

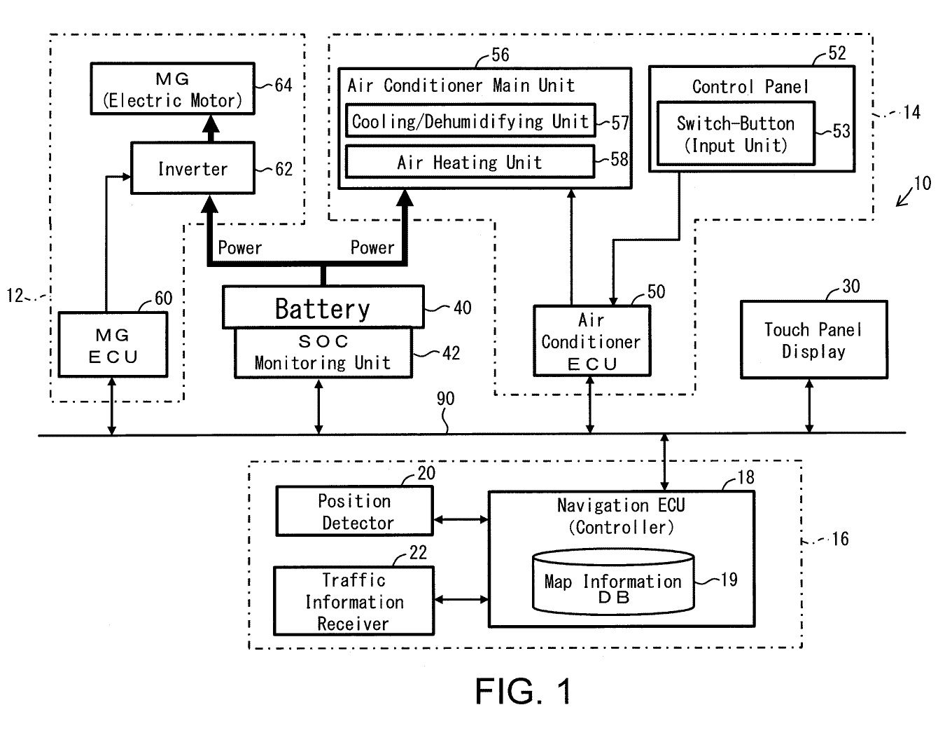

FIG. 1 is a schematic block diagram showing the electrical configuration of an electrically powered vehicle 10 and the parts of the electrically powered vehicle 10 that are relevant to the embodiment. The electrically powered vehicle 10 is a Battery Electric Vehicle (BEV) that uses only the electric motor 64 as the driving source for driving. The electrically powered vehicle 10 includes the battery 40, the SOC monitoring unit 42, the motor unit 12, the air conditioner 14, the navigation device 16, and touch panel display 30.

(Battery) The battery 40 is a rechargeable battery such as a lithium-ion battery. The battery 40 provides power to the electric motor 64 and the air conditioner main unit 56. The electrically powered vehicle 10 includes a charging device, which is not shown in the diagram. The charging device is a device for charging the battery 40. The charging device includes a charging inlet to which a charging connector is connected. The charging connector is located at the charging spot. The battery 40 is charged when the charging connector is connected to the charging inlet.

### (SOC Monitoring Unit)

The SOC monitoring unit 42 is a device that monitors the remaining amount of electricity stored (SOC: State Of Charge) of the battery 40. The SOC monitoring unit 42 includes various sensors, such as a current sensor that detects the current of the battery 40, a temperature sensor that detects the temperature of the battery 40, and a voltage sensor that detects the voltage of the battery 40. The SOC monitoring unit 42 estimates the SOC of the battery 40 based on the detected values of various sensors. The methods of estimating SOC are known, and the SOC monitoring unit 42 may estimate the SOC by any of these methods. The SOC may be estimated, for example, by using the Open Circuit Voltage (OCV) of the battery 40, or by using the integrated value of the charging and discharging current of the battery 40.

### (Motor Unit)

The motor unit 12 includes the electric motor (the motor generator) 64, the inverter 62, and the MG-ECU 60. The electric motor 64 is the driving source for the electrically powered vehicle 10. The inverter 62 is a power conversion device that converts the discharge output (direct current) of the battery 40 into a form of power (three-phase alternating current) that drives the electric motor 64. Thus, the power from the battery 40 is supplied to the electric motor 64 via the inverter 62. The MG-ECU 60 (ECU: Electronic Control Unit) is a computer that controls the electric motor 64 via the inverter 62.

### (Air Conditioner)

The air conditioner 14 includes the air conditioner main unit 56, the air conditioner ECU 50, and the control panel 52.

The air conditioner main unit 56 is a device for air conditioning the interior of the electrically powered vehicle 10, for example, located in front of the instrument panel of the electrically powered vehicle 10. The air conditioner main unit 56 includes a blower (not shown) that generates an air flow (blown air) toward the cabin. The air conditioner main unit 56 includes the cooling and dehumidifying unit 57 and the air heating unit 58. The cooling and dehumidifying unit 57 is a device that cools and dehumidifies the blown air as the air passes around an evaporator (not shown). The air heating unit 58 is a device that heats the blown air as the air passes around a heater core (not shown).

The cooling and dehumidifying unit 57 has a refrigerant circuit in which a refrigerant circulates. The refrigerant circuit includes a compressor, a condenser, a receiver tank, an expansion valve, and an evaporator. The air heating unit 58 has a hot water circuit in which a hot water circulates. The hot water circuit includes a reserve tank, an electric water pump, a water heater, and a heater core. The air conditioner main unit 56 includes an internal air inlet, an outside air inlet, an internal air/outside air switching door, an air-mix door, air outlet doors, and air outlets (air outlets for blower air to the cabin), etc. The air sent to the blower is taken in through the internal air inlet and/or the outside air inlet. The internal air/outside air switching door changes the opening degree of the internal air inlet and the outside air inlet. The blower directs the air through the cooling and dehumidifying unit 57 (evaporator) toward the air heating unit 58 (heater core). The air-mix door changes the ratio of air that passes through the air heating unit 58 (heater core) to air that bypasses the air heating unit 58 (heater core). The configuration of the air conditioner main unit 56 is known, and is disclosed in, for example, JP 2020-199988 A.

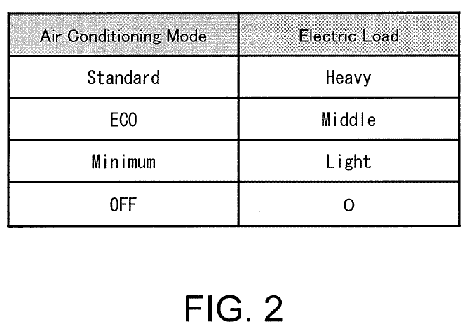

The control panel 52 includes, for example, a liquid crystal display and a plurality of switches to receive instructions from the occupant on the set temperature and other settings of the air conditioner 14. The control panel 52 includes the switch-button 53 (the input unit) for switching the air conditioning modes. The air conditioner main unit 56 can operate in multiple air conditioning modes with different electric loads, as shown in FIG. 2. Each time the user presses the switch-button 53, the air conditioning mode of the air conditioner 14 is switched. The control panel 52 is connected to the air conditioner ECU 50, and the operating information received from occupants is input to the air conditioner ECU 50.

The air conditioner ECU 50 (ECU: Electronic Control Unit) is a computer that controls the air conditioner main unit 56. The air conditioner ECU 50 is connected to an internal air temperature sensor that detects the temperature inside the vehicle, an outside air temperature sensor that detects the temperature outside the vehicle (outside temperature), and a solar radiation sensor that detects solar radiation (all not shown). The values detected by each sensor are input to the air conditioner ECU 50. The air conditioner ECU 50 calculates the target air outlet temperature (TAO) based on the set temperature, the interior temperature, the outside air temperature, and solar radiation. The set temperature is set by the occupant at the control panel 52. The interior temperature is detected by the internal air temperature sensor. The outside air temperature is detected by the outside air temperature sensor. The solar radiation is detected by the solar radiation sensor. The target air outlet temperature (TAO) is the target temperature of the air blown out of the air outlets. Based on the TAO, the air conditioner ECU 50 controls the blower, cooling and dehumidifying unit 57, air heating unit 58, internal air/outside air switching door, air-mix door, etc. The method of calculating TAO is known and disclosed in, for example, JP 2020-199988 A.

When the air conditioning mode is “Standard” (see FIG. 2), the air conditioner ECU 50 controls the air conditioner main unit 56 by the method described above, but when the air conditioning mode is “ECO” or “Minimum”, the air conditioner main unit 56 is controlled so that the electric load of the air conditioner main unit 56 is reduced compared to “Standard”. For example, the air conditioner ECU 50 controls the air conditioner main unit 56 so that the air conditioner main unit 56 operates with 30% less power consumption in the air conditioning mode “ECO” compared to the power consumption of the air conditioner main unit 56 in the air conditioning mode “Standard”. For example, the air conditioner ECU 50 controls the air conditioner main unit 56 so that the air conditioner main unit 56 operates with 70% less power consumption in the air conditioning mode “Minimum” compared to the power consumption of the air conditioner main unit 56 in the air conditioning mode “Standard”. The ratio of 30% or 70% is example. For example, the compressor operation of the cooling and dehumidifying unit 57 and the water heater operation of the air heating unit 58, determined by the above method as the air conditioning mode “Standard”, are restricted to reduce the electric load in the air conditioning mode “ECO” or “Minimum”. When the air conditioning mode is “OFF”, the air conditioner ECU 50 stops the operation of the air conditioner main unit 56.

### (Navigation Device)

The navigation device 16 includes a navigation ECU 18, a positional information detector 20, and a traffic information receiver 22.

The navigation ECU 18 (ECU: Electronic Control Unit) is a controller that controls the display of information such as guidance route from the current location to the destination on the touch panel display 30 (hereinafter referred to as “display 30” as appropriate). The navigation ECU 18 receives the destination and various instructions, etc. from the user via the touch panel display 30.

The map information database (DB) 19 is stored in the non-volatile memory of the navigation ECU 18. The map information DB 19 includes map information. The map information includes the nodes such as intersections and dead ends, the links connecting the nodes, and information about facilities including the charging spots. The map information includes positional information for each node, distance information for each link, slope information at each link, and location information for each facility. The map information used by navigation ECU 18 may be obtained through communication with a server outside the vehicle, in addition to or instead of information obtained from the map information DB.

The position detector 20 and the traffic information receiver 22 are connected to the navigation ECU 18. The position detector 20 receives radio waves from GPS satellites or other satellites and obtains the current location of the vehicle based on the radio waves. The position detector 20 may obtain the current location of the vehicle from radio waves received from a mobile base station or other sources. The position detector 20 outputs positional information indicating the vehicle's current location to the navigation ECU 18.

The traffic information receiver 22 receives road traffic information provided by FM multiplex broadcasts or other means. The road traffic information includes traffic congestion information and road regulation information. The traffic information receiver 22 outputs the received road traffic information to the navigation ECU 18.

The navigation ECU 18 displays on the display 30 a guidance route from the current location to the destination based on map information, the vehicle's current location obtained by the position detector 20, the destination specified by the user, and road traffic information obtained by the traffic information receiver 22. The navigation ECU 18 also calculates the distance of the guidance route from the current location to the destination and the time required from the current location to the destination, and displays them on the display 30 as appropriate.

### (ECU)

Here, ECU (Electronic Control Unit) such as the MG-ECU 60, the air conditioner ECU 50, or the navigation ECU18 is explained. The ECU includes a processor (CPU: Central Processing Unit), RAM (Random Access Memory), ROM (Read-Only Memory), nonvolatile memory (e.g., flash memory), and I/O interfaces. The processor uses RAM to perform processing according to programs and data stored in advance in ROM and nonvolatile memory, thereby enabling the ECU to realize various controls and functions.

### (Connection Between Devices)

The MG-ECU 60, the SOC monitoring unit 42, the air conditioner ECU 50, the navigation ECU 18, and the display 30 are connected to each other via the communication bus 90. Each device connected to the communication bus 90 is configured to communicate with each other via in-vehicle network communication. As another embodiment, the navigation ECU 18 and the display 30 may be connected by one-to-one wiring.

### (Processing by the Navigation ECU)

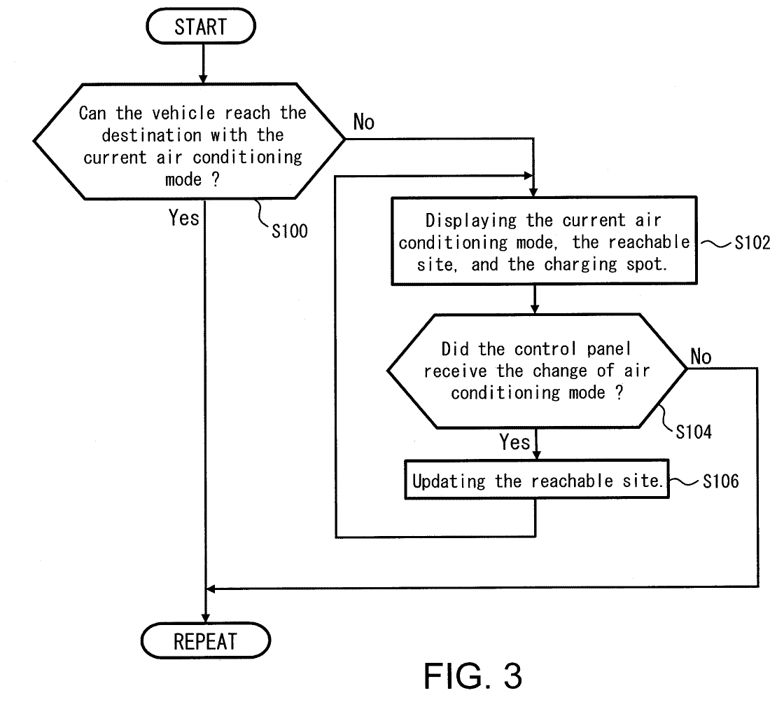

FIG. 3 is a flowchart showing the process performed by the navigation ECU 18. The navigation ECU 18 executes the flow shown in FIG. 3 at a predetermined cycle. It is assumed that the destination of the vehicle is specified by the user (the occupant) before the flow in FIG. 3 is executed.

At step S100, the navigation ECU 18 checks whether the vehicle can reach its destination in the current air conditioning mode. Specifically, the navigation ECU 18 first obtains the remaining amount of electricity stored (SOC) of the battery 40 from the SOC monitoring unit 42. Then, the navigation ECU 18 calculates the amount of electricity for traveling that is required for the vehicle to travel from the current location to the destination (details are described below). The navigation ECU 18 also calculates the electricity amount for air conditioning required by the air conditioner main unit 56 when the air conditioner main unit 56 is operated in the currently selected air conditioning mode during the vehicle traveling from the current location to the destination (details are described below).

Then, the navigation ECU 18 calculates the total amount of electricity by adding the electricity amount for air conditioning to the electricity amount for traveling. If the remaining amount of electricity stored in the battery 40 is equal to or greater than the above total amount of electricity, the navigation ECU 18 determines that the vehicle is capable of reaching the destination (S100: Yes). On the other hand, if the remaining amount of electricity stored in the battery 40 is less than the above total amount of electricity, the navigation ECU 18 judges that the vehicle cannot reach the destination (S100: NO) and proceeds to step S102.

At step S102, the navigation ECU 18 displays on the display 30 the site (the reachable site) between the current location and the destination, the site (the reachable site) is a place where the vehicle can reach in the currently selected air conditioning mode. The method of obtaining the reachable site is described below.

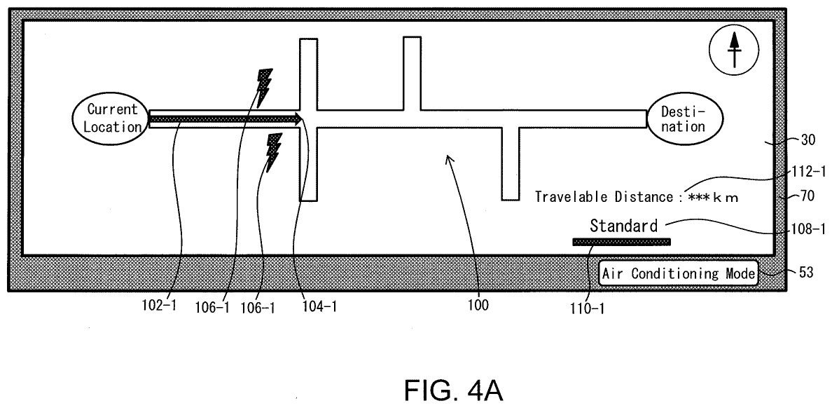

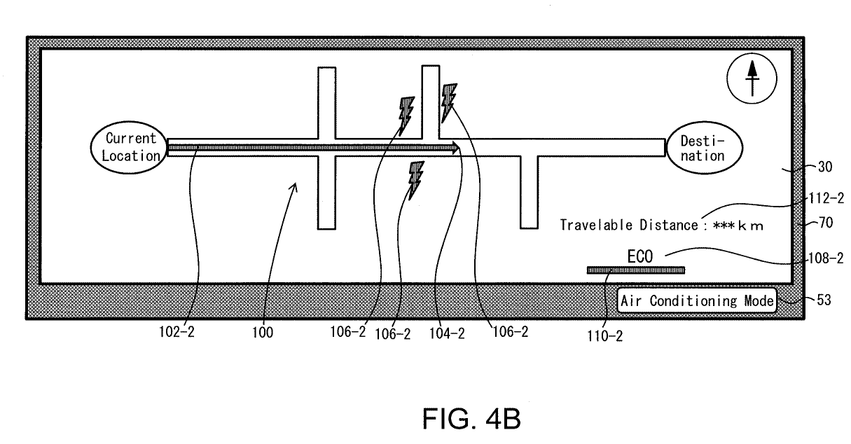

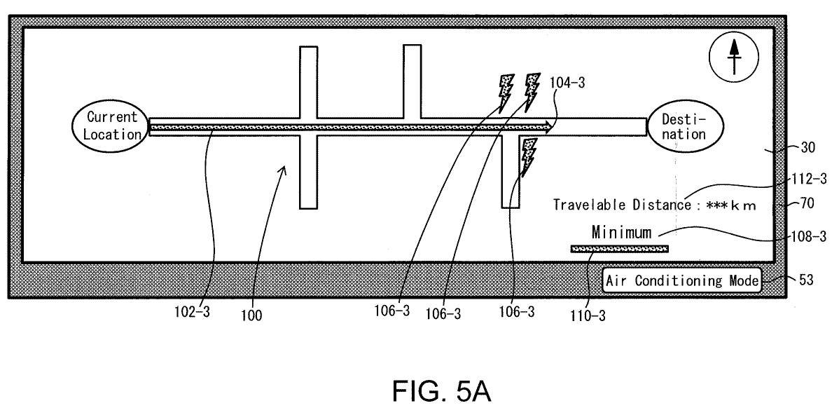

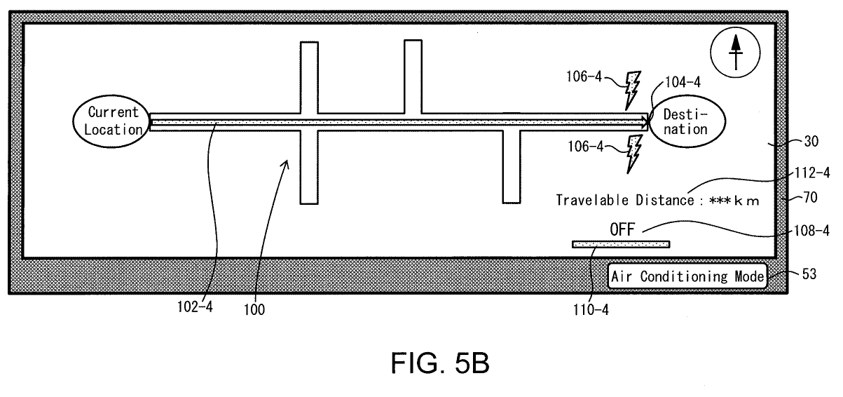

FIGS. 4A, 4B, 5A, and 5B are examples of the display screen at step S102. FIG. 4A is an example of the display screen when the air conditioning mode is “Standard”. FIG. 4B is an example of the display screen when the air conditioning mode is “ECO”. FIG. 5A is an example of the display screen when the air conditioning mode is “Minimum”. FIG. 5B is an example of the display screen when the air conditioning mode is “OFF”. The map 100 shown on the display 30 in each figures is depicted in simplified form. In each figures, a reference numeral suffixed with “−1” indicates a reference numeral related to the air conditioning mode “Standard”, and similarly, a reference numeral suffixed with “−2”, “−3”, or “−4” indicates a reference numeral related to the air conditioning mode “ECO”, “Minimum”, or “OFF” respectively. In the following explanation, when it is not necessary to explain the difference between the air conditioning modes, the reference numerals omitting “−1” through “−4” at the end are used.

The instrument panel 70 of the vehicle has the display 30 and the switch-button 53 for switching the air conditioning modes. The display 30 shows the map 100 that includes the current location and the destination, the guidance line 102, the charging spot marks 106, and the available driving distance 112 (the travelable distance). The guidance line 102 is the line from the current location to the site that the vehicle can reach in the currently selected air conditioning mode. The tip of the guidance line 102 is the reachable site 104. The charging spot mark 106 is the mark indicating the location of the charging spot around the reachable site 104. The charging spot indicated by the charging spot mark 106 is a charging spot that is reachable by the vehicle in the currently selected air conditioning mode. The travelable distance 112 is the distance the vehicle can travel in the currently selected air conditioning mode.

The display 30 also shows the current air conditioning mode 108 and the indicator 110 indicating the type of air conditioning mode. The indicator 110 is a color line that indicates the type of air conditioning mode. For example, the indicator 110-1 for the air conditioning mode “Standard” in FIG. 4A is blue, the indicator 110-2 for the air conditioning mode “ECO” in FIG. 4B is green, the indicator 110-3 for the air conditioning mode “Minimum” in FIG. 5A is yellow, and the indicator 110-4 for the air conditioning mode “OFF” in FIG. 5B is red. The guidance line 102 and the charging spot mark 106 are the same color as the indicator 110. That is, for example, in the air conditioning mode “Standard” of FIG. 4A, the guidance line 102-1 and the charging spot marks 106-1 are blue, the same color as the indicator 110-1, and in the air conditioning mode “ECO” of FIG. 4B, the guidance line 102-2 and the charging spot marks 106-2 are green, the same color as the indicator 110-2. The same embodiment applies to the air conditioning mode “Minimum” and “OFF”. In each figures, the elements with identical hatching mean that they have the same color. The display screen described above allow the user to clearly identify the guidance line 102, the reachable site 104, and the charging spot marks 106, which correspond to the air conditioning mode 108 (the indicator 110). The colors listed above are examples. In this embodiment, each element is the same color as described above, but each element may be represented by the same pattern.

According to the display screens in FIGS. 4A, 4B, 5A, and 5B, the user can know the site (the reachable site 104) that the vehicle can reach when the air conditioner 14 is operated in the currently selected air conditioning mode. As described above, the charging spots (the charging spot marks 106) in the vicinity of the reachable site 104 are displayed on the display 30. This allows the user to easily move the vehicle to the charging spot and charge the vehicle's battery.

At step S104 in FIG. 3, the navigation ECU 18 checks, via the air conditioner ECU 50, whether the switch-button 53 is pressed by the user (i.e., whether the air conditioning mode is switched to another mode). If step S104 is “Yes”, the navigation ECU 18 obtains the site (the reachable site) that the vehicle can reach in the newly selected air conditioning mode (S106). Then, at step S102, the navigation ECU 18 displays the guidance line 102, the reachable site 104, the charging spot marks 106, and other information related to the newly selected air conditioning mode on the display 30. In other words, each time the user presses the swith-button 53, the display screen changes in the following order: (FIG. 4A, 4B, 5A, 5B, 4A, . . . ). This allows the user to switch the air conditioning modes and know the reachable site (the cruising range) in each air conditioning mode. Thus, the user can determine the air conditioning mode based on the balance between cabin comfort and cruising range.

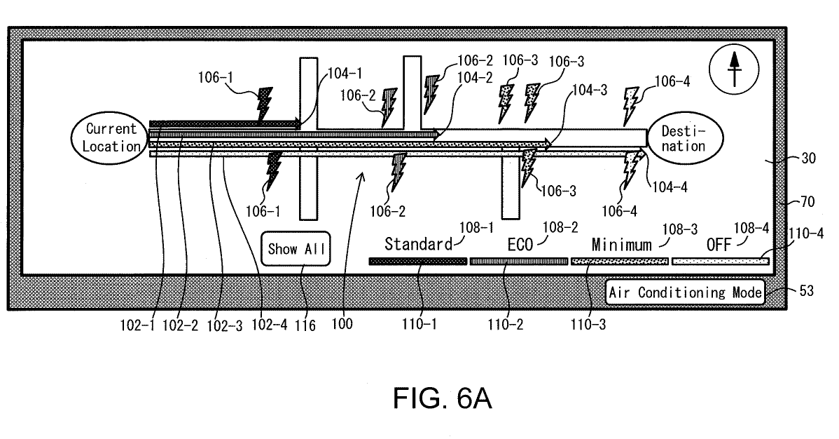

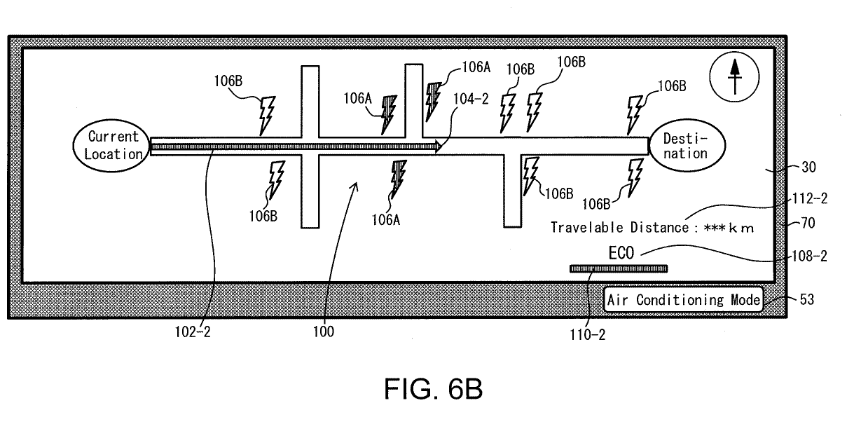

As another embodiment, as shown in FIG. 6A, the navigation ECU 18 may display the “Show All” button 116 on the touch panel display 30. When the navigation ECU 18 receives a signal indicating that the user has touched the “Show all” button 116, the indicators 110, the guidance lines 102, the reachable sites 104, and the charging spot marks 106 for all air conditioning modes are displayed on the touch panel display 30 as shown in FIG. 6A. This embodiment also allows the user to know the reachable points in each air conditioning mode and the charging spots around those sites.

As further another embodiment, as shown in FIG. 6B, the navigation ECU 18 may 18 may display the charging spot marks 106A of the charging spots around the site (the reachable point 104-2) that the vehicle can reach in the currently selected air conditioning mode (“ECO” in FIG. 6B) in a different color or pattern from the charging spot marks 106B of the other charging spots. This embodiment allows the user to clearly identify the charging spots (the charging spot marks 106A) corresponding to the vehicle's reachable site 104-2.

### (Calculation Method of Electricity Amount)

As described above, in step S100 of FIG. 3, the navigation ECU 18 calculates the electricity amount for traveling and the electricity amount for air conditioning. Here, an example of how the electricity amount for traveling and the electricity amount for air conditioning are calculated in step S100 is described.

The navigation ECU 18 calculates the electricity amount for traveling, which indicates the amount of electricity required for traveling from the current location to the destination. Navigation ECU 18 first obtains the distance of the guidance route from the information on the guidance route from the current location to the destination. The memory of the MG-ECU 60 stores in advance the average electricity amount consumed by the battery 40 per certain distance (the average electricity amount for traveling). The navigation ECU 18 obtains the average electricity amount for traveling from the MG-ECU 60. Then, the navigation ECU 18 calculates the electricity amount for traveling by multiplying the distance of the guidance route by the average electricity amount for traveling (the electricity amount per unit distance).

The electricity amount for traveling may be corrected using traffic information including congestion on the guidance route from the current location to the destination. For example, if there is a congested section, the accelerator and brake pedals are operated more frequently than if there is no congestion, so the electricity amount for traveling may be corrected to be higher when there is a congested section. For example, if there is a suburban road on the guidance route, there are fewer traffic signals, etc., than in an urban area, and the accelerator and brake pedals are operated less frequently, so the electricity amount for traveling may be corrected to be less when there is a suburban road. The electricity amount for traveling may be corrected by taking into account uphill and downhill sections in the guidance route. That is, if there is an uphill section, it may be corrected so that the electricity amount for traveling is increased, and if there is a downhill section, it may be corrected so that the electricity amount for traveling is decreased.

The navigation ECU 18 calculates the electricity amount for air conditioning required by the air conditioner main unit 56 when the air conditioner main unit 56 is operated in the currently selected air conditioning mode during the vehicle traveling from the current location to the destination. The navigation ECU 18 first obtains the current power consumption of the air conditioner main unit 56 (the electricity for air conditioning, the power consumption in the currently selected air conditioning mode) from the air conditioner ECU 50. Then, the navigation ECU 18 obtains the time required for the vehicle to travel from the current location to the destination. The navigation ECU 18 then calculates the electricity amount for air conditioning by multiplying the electricity for air conditioning (the electricity amount per unit time) by the required time.

The power consumption of the air conditioner main unit 56 may be not constant and can change over time. Generally, when the air conditioner main unit 56 is operated, the cabin temperature (internal air temperature) becomes closer to the set temperature specified by the user, so the power consumption of the air conditioner main unit 56 tends to decrease. Therefore, the electricity amount for air conditioning calculated above may be corrected to obtain a more accurate electricity amount for air conditioning. For example, a table of correction values (e.g., values less than 1.0) tied to four conditions consisting of the set temperature of the air conditioner 14, the internal air temperature, the electricity for air conditioning, and the operating time of the air conditioner main unit 56 is stored in memory in advance. Then, the navigation ECU 18 obtains from the table the correction value associated with the current set temperature of the air conditioner 14, the internal air temperature, the electricity for air conditioning, and the operating time (the time required for the vehicle to travel from the current location to the destination). Then, the navigation ECU 18 multiplies the electricity amount for air conditioning calculated above by the correction value to correct the electricity amount for air conditioning.

The method for calculating the electricity amount for traveling and the electricity amount for air conditioning is also disclosed in Patent Literature 1 (JP 2011-255686 A). The navigation ECU 18 may calculate the electricity amount for traveling and the electricity amount for air conditioning using the method described in Patent Literature 1.

### (Method for Obtaining Reachable Site)

As described above, in step S102 of FIG. 3, the navigation ECU 18 obtains the site (the reachable site) that the vehicle can reach in the currently selected air conditioning mode. An example of the method for obtaining reachable site is described here.

The navigation ECU 18 first obtains the time required for the vehicle to travel from the current location to the destination. Then, the navigation ECU 18 calculates the average electricity for traveling (the electricity consumption per unit time) by dividing the electricity amount for traveling (the electricity amount required for traveling from the current location to the destination) by the required time. The navigation ECU 18 calculates the average electricity for air conditioning (the electricity consumption per unit time) by dividing the electricity amount for air conditioning (the electricity amount required by the air conditioner when the air conditioner is operated in the currently selected air conditioning mode during traveling from the current location to the destination) by the time required.

Then, the navigation ECU 18 calculates the total average electricity, which is the sum of the average electricity for traveling and the average electricity for air conditioning. Then, the navigation ECU 18 divides the remaining amount of electricity stored (SOC) in the battery 40 by the total average electricity (the electricity consumption per unit time) to determine the time that the electrically powered vehicle 10 can operate (the operation available time). Then, the navigation ECU 18 obtains the site (the reachable site) that the vehicle can reach from the information on the guidance route and the operation available time. The method described here is an example; other methods may be used.

### OTHER EMBODIMENTS

In the embodiment described above, the electrically powered vehicle 10 is the Battery Electric Vehicle (BEV), but, the electrically powered vehicle 10 may also be the Plug-in Hybrid Electric Vehicle (PHEV). For example, when the PHEV is driving in EV mode (the mode in which only the electric motor is the driving source), the navigation ECU 18 of the PHEV may display on the display, as in the above embodiment, the information about the reachable site of the vehicle and the positional information of the charging spot around the site.

In the embodiment described above, the navigation ECU 18 performed the process of determining the electricity amount for traveling, the electricity amount for air conditioning, and the reachable site, but, other computer may perform those processes in addition to or instead of the navigation ECU 18.

The remaining amount of electricity stored (SOC) in the battery 40 used in the process described above may or may not be based on 0 [Ah]. For example, the remaining amount of electricity stored (SOC) in the battery 40 may be based on the lower limit of battery capacity (the value greater than 0 [Ah]), which is determined from the perspective of preventing battery deterioration.

In the above, it is explained that the electricity for air conditioning changes when the air conditioning mode is switched, and the display shows the display screen corresponding to the current air conditioning mode (i.e., the reachable site, the charging spots, etc.). However, the air conditioning mode may not be a required configuration. The air conditioner can operate based on the air conditioning settings (the set temperature, the airflow amount, etc.) from the user, and the electricity for air conditioning changes according to the air conditioning settings. Therefore, the controller may obtain the electricity for air conditioning according to the air conditioning settings set by the user (e.g., temperature, humidity, airflow amount, heating/cooling, dehumidification, etc.). Then, based on the obtained electricity for air conditioning, the controller may cause the display to show the display screen (the indication of the reachable site, the charging spots, etc.).

1. A navigation device mounted on an electrically powered vehicle comprising an electric motor as a driving source, an air conditioner, and a battery that supplies electricity to the electric motor and the air conditioner, the navigation device comprising:
a controller that operates a display to display a guidance route from a current location to a destination specified by a user,
wherein the controller is configured to obtain an electricity amount for traveling and an electricity amount for air conditioning,
wherein the electricity amount for traveling denotes an amount of electricity needed by the vehicle to travel from the current location to the destination,
wherein the electricity amount for air conditioning denotes an amount of electricity needed by the air conditioner to keep functioning during travel from the current location to the destination,
wherein the controller is configured to add the electricity amount for air conditioning to the electricity amount for traveling to obtain a total amount of electricity, and
when a remaining amount of electricity stored in the battery is less than the total amount of electricity, the controller operates the display to show a site where the vehicle is reachable with the remaining amount of electricity and is located between the current location and the destination, along with positional information on a charging spot around the site.

2. The navigation device according to claim 1, wherein
the air conditioner is configured to be operable in a plurality of air conditioning modes comprising a mode to reduce an electric load.

3. The navigation device according to claim 2, wherein
the vehicle comprises an input unit configured to receive an input of an air conditioning mode selected from the plurality of air conditioning modes by a user, and
the controller is configured to operate the display to show a site where the vehicle is reachable with the air conditioner actuated in the air conditioning mode received by the input unit, along with positional information on a charging spot around the site reachable in the received air conditioning mode.

4. The navigation device according to claim 2, wherein
the controller is configured to operate the display to show a map on which a guidance line is indicated on a route from the current location to a site where the vehicle is reachable in a currently selected air conditioning mode, with a charging spot mark indicated at a location of a charging spot around the site reachable in the currently selected air conditioning mode, and
the controller is further configured to operate the display to show the guidance line and the charging spot mark with a same color or a same pattern.

5. The navigation device according to claim 3, wherein
the controller is configured to operate the display to show a map on which a guidance line is indicated on a route from the current location to the site where the vehicle is reachable in the selected air conditioning mode, with a charging spot mark indicated at a location of the charging spot around the site reachable in the selected air conditioning mode, and
the controller is further configured to operate the display to show the guidance line and the charging spot mark with a same color or a same pattern.

6. The navigation device according to claim 2, wherein
the controller is configured to operate the display to show a map on which a charging spot mark is indicated at a location of a charging spot with a color or a pattern, and
the controller is further configured to operate the display to show a charging spot mark indicating, with another color or another pattern, a charging spot around a site where the vehicle is reachable in a currently selected air conditioning mode.

7. The navigation device according to claim 3, wherein
the controller is configured to operate the display to show a map on which a charging spot mark is indicated at a location of a charging spot with a color or a pattern, and
the controller is further configured to operate the display to show a charging spot mark indicating, with another color or another pattern, the charging spot around the site where the vehicle is reachable in the selected air conditioning mode.

8. An electrically powered vehicle, comprising:
an electric motor as a driving source;
an air conditioner;
a battery that supplies power to the electric motor and the air conditioner; and
a navigation device comprising a controller which is configured to operate a display to show a guidance route from a current location to a destination specified by a user,
wherein the controller in the navigation device is further configured to obtain an electricity amount for traveling and an electricity amount for air conditioning,
wherein the electricity amount for traveling denotes an amount of electricity needed by the vehicle to travel from the current location to the destination,
wherein the electricity amount for air conditioning denotes an amount of electricity needed by the air conditioner to keep functioning during travel from the current location to the destination,
wherein the controller in the navigation device is further configured to add the electricity amount for air conditioning to the electricity amount for traveling to obtain a total amount of electricity, and
when a remaining amount of electricity stored in the battery is less than the total amount of electricity, the controller in the navigation device operates the display to show a site where the vehicle is reachable with the remaining amount of electricity and is located between the current location and the destination, along with positional information on a charging spot around the site.
